(19) United States
(12) Patent Application Publication
(10) Pub. No.: US 2022/0093987 A1
(43) Pub. Date: Mar. 24, 2022

(54) APPARATUS FOR INSULATING BATTERY OF ELECTRIC VEHICLE

(71) Applicants: HYUNDAI MOTOR COMPANY, Seoul (KR); Kia Corporation, Seoul (KR)

(72) Inventor: Hyunchang KANG, Seoul (KR)

(73) Assignees: HYUNDAI MOTOR COMPANY, Seoul (KR); Kia Corporation, Seoul (KR)

(21) Appl. No.: 17/392,813

(22) Filed: Aug. 3, 2021

(30) Foreign Application Priority Data
Sep. 24, 2020 (KR) 10-2020-0123472

(51) Int. Cl. H01M 10/658; H01M 10/613; H01M 10/625; H01M 10/6563

(52) U.S. Cl. CPC H01M 10/658; H01M 10/613; H01M 2220/20; H01M 10/6563; H01M 10/625

(57) ABSTRACT

An apparatus for insulating a battery of an electric vehicle includes: a vehicle body; a battery pack provided in the vehicle body and including an exterior case and a battery module; and an insulation sheet provided between the battery module and the exterior case, wherein the exterior case includes an upper case and a lower case provided below the upper case, and wherein the insulation sheet is provided between an upper surface of the lower case and a module cover forming an exterior of the battery module.

### CROSS-REFERENCE TO RELATED APPLICATION

This application claims priority to and the benefit of Korean Patent Application No. 10-2020-0123472, filed on Sep. 24, 2020, the entire contents of which are incorporated herein by reference.

### FIELD

The present disclosure relates to an apparatus for insulating a battery of an electric vehicle.

### BACKGROUND

The statements in this section merely provide background information related to the present disclosure and may not constitute prior art.

An electric vehicle is a vehicle that uses a battery engine operated by electrical energy outputted from a battery.

Since such an electric vehicle uses a battery in which a plurality of secondary cells capable of being charged and discharged are formed as a single pack as a main power source, it has the advantage of no emissions and very little noise.

In addition, a hybrid vehicle is a vehicle that uses two or more power sources, for example, both an engine and a battery engine, as an intermediate vehicle between a vehicle using an internal combustion engine and an electric vehicle.

In the vehicle using electrical energy as described above, since performance of the battery directly affects performance of the vehicle, a battery management system is desired to efficiently manage charging and discharging of each battery cell by measuring a voltage of each battery cell, and a voltage and current of an entire battery, and to provide maximum performance of the battery cell by determining whether each battery cell is degraded.

Recently, the use of lithium-ion batteries in such electric vehicles is increasing. The lithium-ion battery is a type of rechargeable battery, and has a multilayer structure including a positive electrode activated by various mixed oxides or olivine, a negative electrode activated by a specific carbon, and a separator immersed in an organic electrolyte.

In a normal operation state thereof, electrical energy is converted into chemical energy and stored during charging, and the stored chemical energy is converted into electrical energy during discharging. In more detail, during charging, lithium in the positive electrode is ionized to move layer by layer toward the negative electrode. During discharging, ions move to the positive electrode to return to their original compound.

In such a lithium-ion battery, a state known as self-heating may occur in extreme situations of overvoltage, overcurrent, or overtemperature. Due to the self-heating, the lithium-ion battery may enter a thermal runaway state. The self-heating means a state in which a temperature inside a battery cell rises due to an electrical-chemical structure inside the battery cell.

When the thermal runaway occurs inside a battery module, it may cause very extreme and severe damage. When the thermal runaway occurs, a very little amount of oxygen may be generated, and an internal temperature may rise to 800 degrees Celsius or more.

When such a situation occurs, a fire may occur inside the vehicle, excessive gas may be generated, or a case in which a lithium-ion battery cell is accommodated may be destroyed.

Particularly, when a fire occurs due to the thermal runaway, the insulation of a battery pack is destroyed and a high voltage may be applied to a vehicle body. At this time if an occupant of the vehicle comes in contact with the vehicle body flowing high voltage, there is a possibility of an electric shock.

The above information disclosed in this Background section is only for enhancement of understanding of the background of the disclosure, and therefore it may contain information that does not form the prior art that is already known to a person of ordinary skill in the art.

### SUMMARY

The present disclosure provides an apparatus for insulating a battery of an electric vehicle that may inhibit an occupant from being exposed to an electric shock accident when an insulation of a battery pack is destroyed due to a thermal runaway of a battery for the electric vehicle.

An apparatus for insulating a battery of an electric vehicle according to an exemplary form of the present disclosure may include a vehicle body, a battery pack provided in the vehicle body and including an exterior case and a battery module, and an insulation sheet provided between the battery module and the exterior case.

The exterior case may include an upper case and a lower case provided below the

Attorney Docket No. 15438-1747 upper case, and the insulation sheet may be provided between an upper surface of the lower case and a module cover that forms exterior of the battery module.

The insulation sheet may be attached to the module cover of the battery module by an adhesive or adhesive tape.

The insulation sheet may be pressed to the exterior case of the battery pack to be fixedly installed in a state in which the insulation sheet is bonded to the module cover by the adhesive or the adhesive tape.

The insulation sheet may be attached to an exterior case of the battery pack by an adhesive or adhesive tape.

The insulation sheet may be pressed to the module cover of the battery module to be fixedly installed in a state in which the insulation sheet is bonded to the exterior case by the adhesive or the adhesive tape.

The insulation sheet may be formed to be larger than a size of the battery module.

The insulation sheet may include a ceramic material.

An apparatus for insulating a battery for an electric vehicle according to another exemplary form of the present disclosure may include a vehicle body, a battery pack provided in the vehicle body and including an exterior case and a battery module, a cooling fan provided inside the exterior case and configured to cool the battery module, a battery management system provided inside the exterior case and configured to manage a state of the battery module, and an insulation sheet provided between the battery module and the exterior case.

The exterior case may include an upper case and a lower case provided below the upper case, and the insulation sheet may be provided between an upper surface of the lower case and a module cover that forms exterior of the battery module.

The insulation sheet may be provided between the cooling fan and the battery management system.

The insulation sheet may be attached to the module cover of the battery module by an adhesive or adhesive tape.

The insulation sheet may be pressed to the exterior case of the battery pack to be fixedly installed in a state in which the insulation sheet is bonded to the module cover by the adhesive or the adhesive tape.

The insulation sheet may be attached to an exterior case of the battery pack by adhesive or adhesive tape.

The insulation sheet may be pressed to the module cover of the battery module to be fixedly installed in a state in which the insulation sheet is bonded to the exterior case by the adhesive or the adhesive tape.

The insulation sheet may be formed to be larger than the battery module.

The insulation sheet may include a ceramic material.

According to an exemplary form of the present disclosure, since the insulation sheet 400 is provided between the battery module 300 and the battery pack 200, when a fire occurs in the battery pack 200 due to the thermal runaway, it is possible to inhibit the transmission of the high current from the battery module 300 to the vehicle body 100 through the exterior case 210 of the battery pack 200.

Accordingly, when the fire occurs in the battery pack 200 due to the thermal runaway, the high current is not transferred from the battery module 300 to the vehicle body 100 through the exterior case 210 of the battery pack 200 because of the insulation sheet 400. Even if the occupant contacts the vehicle body 100, it is possible to inhibit an electric shock accident.

Further, since the insulation sheet 400 is provided with a flame resisting function, the propagation of the fire to the vehicle body 100 is delayed as much as possible when a fire occurs in the battery pack 200. Thus, it is possible to provide time for the occupant to evacuate from the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an exploded perspective view of an apparatus for insulating a battery of an electric vehicle according to an exemplary form of the present disclosure;

FIG. 2 illustrates a perspective view of an apparatus for insulating a battery of an electric vehicle according to an exemplary form of the present disclosure;

FIG. 3 illustrates an exploded perspective view of a battery module for an electric vehicle according to an exemplary form of the present disclosure; and

FIG. 4 illustrates a schematic view for explaining an operation of an apparatus for insulating a battery of an electric vehicle according to an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In addition, since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

Hereinafter, an apparatus for insulating of a battery of an electric vehicle according to one form of the present disclosure will be described in detail with reference to the accompanying drawings.

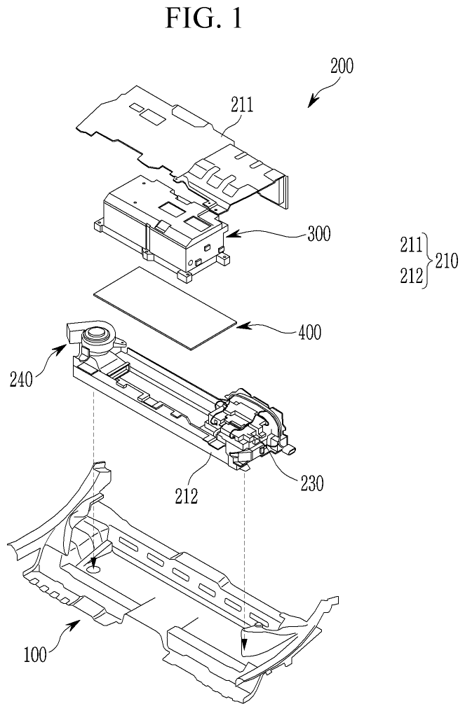

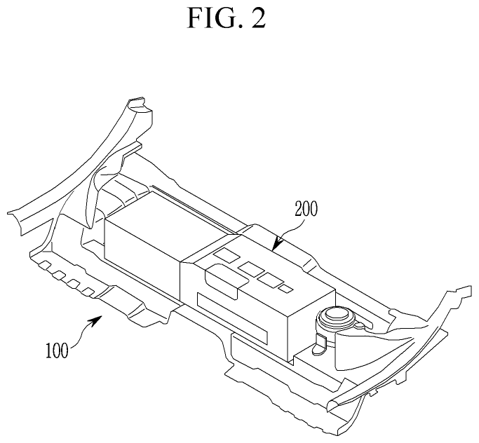

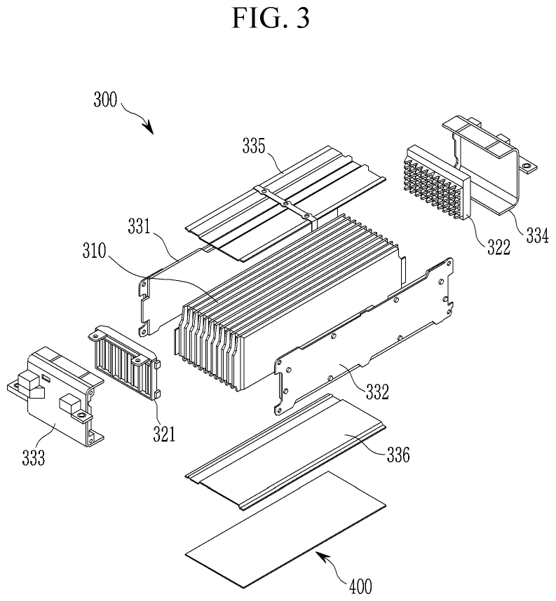

FIG. 1 illustrates an exploded perspective view of an apparatus for insulating a battery of an electric vehicle according to an exemplary form of the present disclosure. FIG. 2 illustrates a perspective view of an apparatus for insulating a battery of an electric vehicle according to an exemplary form of the present disclosure. In addition, FIG. 3 illustrates an exploded perspective view of a battery module for an electric vehicle according to an exemplary form of the present disclosure.

As shown in FIG. 1 to FIG. 3, an apparatus for insulating of a battery of an electric vehicle may include a battery pack 200 including at least one battery module 300, a vehicle body 100 mounted with the battery pack 200, and an insulation sheet 400 provided between the battery pack 200 and the vehicle body 100.

The battery pack 200 may include at least one battery module 300, and the battery module 300 may include a plurality of battery cell 310. That is, the plurality of battery cells 310 may configure the battery module 300, and the plurality of battery modules 300 may configure the battery pack 200. In one form of the present disclosure, the battery cell 310 may be implemented as a pouch type, a prismatic type, or a cylindrical type.

Specifically, the battery pack 200 may include an exterior case 210 forming an exterior, at least one or more battery modules 300 provided inside the exterior case 210, a battery management system 230, and a cooling fan 240.

The exterior case 210 may include an upper case 211 and a lower case 212 provided below the upper case 211. The upper case 211 and the lower case 212 are coupled to form the exterior case 210. The exterior case 210 is made of a metal material (for example, carbon steel or aluminum).

The lower case 212 is provided with a bolt engagement portion for coupling with the vehicle body 100, and the bolt engagement portion may be engaged with the vehicle body 100 through a bolt. At this time, the exterior case 210 is bolted to the vehicle body 100 and is electrically connected to the vehicle body 100. That is, the battery pack 200 is electrically connected the vehicle body 100 so that the battery pack 200 and the vehicle body 100 may be grounded. Accordingly, a ground potential of the battery pack 200 becomes a reference potential of the vehicle body 100.

At least one battery module 300 and a printed circuit board 320 are installed in the exterior case 210 forming an exterior thereof.

The battery module 300 may include a plurality of battery cells 310 and a printed circuit board (PCB) 320 inside a module cover 330 forming an exterior thereof.

When the battery module 300 is mounted inside the exterior case 210 of the battery pack 200, there is a predetermined distance between the battery module 300 and the exterior case 210, and electrical insulation may be maintained between the battery module 300 and the battery pack 200 engaged with the vehicle body 199. Alternatively, when the battery module 300 is mounted inside the exterior case 210 of the battery pack 200, electrical insulation may be maintained between the battery module 300 and the battery pack 200 engaged with the vehicle body 100 by a structure (not shown) supporting the battery module 300.

The module cover 330 may include a left cover 331, a right cover 332, an upper cover 335, a lower cover 336, a front cover 333, and a rear cover 334. The left cover 331, the right cover 332, the upper cover 335, the lower cover 336, the front cover 333, and the rear cover 334 are combined to form the module cover 330, the module cover 330 is provided to surround an outer periphery of the plurality of battery cells 310, and the printed circuit board 320 is provided between the module cover 330 and the battery cell 310.

The plurality of battery cells 310 configuring the battery module 300 are stacked in left and right directions or up and down directions, and the plurality of battery cells 310 may be connected in parallel or in series. The printed circuit boards (PCB) 320 are provided at both ends of the plurality of battery cells 310 stacked in the left and right directions or the up and down directions, and each printed circuit board 320 detects a voltage and temperature of each battery cell 310 to transmit them to the battery management system (BMS) 230.

The battery management system 230 receives information of the battery cell 310 detected by various types of sensors (for example, a temperature sensor, a voltage sensor, etc.) through the printed circuit board 320 to determine a situation of the plurality of battery modules 300, and it manages each battery module 300 to be maintained in an optimal state.

Particularly, the battery management system 230 measures the remaining capacity of the battery, maintains a state of charge (SOC) of the battery at an appropriate level, and measures and manages a temperature of the battery.

The cooling fan 240 is provided inside the exterior case 210 of the battery pack 200 and cools the battery module 300. In an exemplary form of the present disclosure, the cooling fan 240 may be an air-cooled type fan that cools heat generated from the battery module 300.

The battery management system 230 may be mounted on one side (e.g., right) of the lower case 212 of the exterior case 210, and the cooling fan 240 may be mounted on the other side (e.g., left) of the lower case 212.

An insulation sheet 400 is provided between the exterior case 210 of the battery pack 200 and the battery module 300. That is, the insulation sheet 400 may be provided between the exterior case 210 forming exterior of the battery pack 200 and the module cover 330 forming exterior of the battery module 300.

For example, the insulation sheet 400 may be provided between an upper surface of the lower case 212 of the exterior case 210 and a bottom surface of the module cover 330 of the battery module 300. In addition, the insulation sheet 400 may be positioned on an upper surface of the lower case 212 between the battery management system 230 and the cooling fan 240.

The insulation sheet 400 may be formed in a shape that corresponds to the battery module 300. The insulation sheet 400 may be formed larger than the size of the battery module 300 to increase insulation performance. For example, the insulation sheet 400 may be formed to be about 5mm more or larger than the outermost size of the battery module 300.

The insulation sheet 400 may be made of ceramic material, and insulation function and flame resisting function may be additionally obtained by including ceramic material.

The insulation sheet 400 may be attached to the bottom surface of the lower cover 336 of the battery module 300 by an adhesive or adhesive tape. In addition, in a state in which the insulation sheet 400 is bonded to a bottom surface of the lower cover 336 of the battery module 300, the insulation sheet 400 may be pressed to the lower case 212 of the battery pack 200 to be assembled.

Further, the insulation sheet 400 may be attached to the upper surface of the lower case 212 of the battery pack 200 by an adhesive or adhesive tape. In addition, in a state in which the insulation sheet 400 is bonded to the lower case 212 of the battery pack 200, the insulation sheet 400 may be pressed to the lower cover 336 of the battery module 300 to be assembled.

Accordingly, the insulation sheet 400 may be fixedly installed, without moving, between the module cover 330 of the battery module 300 and the exterior case 210 of the battery pack 200.

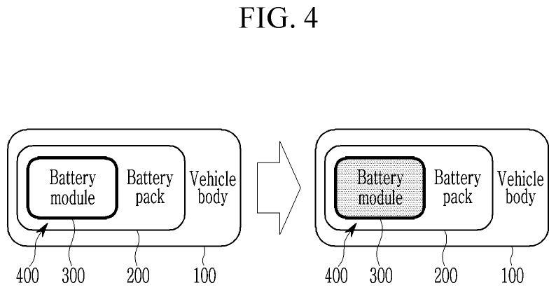

FIG. 4 illustrates a schematic view for explaining an operation of an apparatus for insulating a battery of an electric vehicle according to an exemplary form of the present disclosure.

The left figure of FIG. 4 shows the battery module, the battery pack and the vehicle body in a case where the battery module is normally operated, and the right figure of FIG. 4 shows the battery module, the battery pack and the vehicle body in a case in which there is a fire in the battery module by thermal runaway.

Referring to the left figure of FIG. 4, when the battery pack 200 is normally operated, the battery module 300 is electrically insulated from the battery pack 200, and is electrically insulated from the vehicle body 100 coupled to the battery pack 200.

If a fire occurs due to a thermal runaway of any one battery cell in the battery pack 200, the electrical insulation between the battery module 300 and the exterior case 210 of the battery pack 200 is destroyed, and the battery module 300 and the vehicle body 100 may be shorted.

When the electrical insulation between the battery pack 200 and the exterior case 210 is destroyed, since the battery module 300 and the vehicle body 100 are electrically connected, a high current flows to the vehicle body 100 due to a high voltage generated by the battery module 300. As a result, an electric shock accident may occur to an occupant in the vehicle body 100.

However, according to an exemplary form of the present disclosure, since the insulation sheet 400 is provided between the battery module 300 and the exterior case 210 of the battery pack 200, it is possible to maintain the electrical insulation between the battery module 300 and the battery pack 200 (see the right figure of FIG. 4) although the thermal runaway occurs in the battery cell 310 of the battery module 300. Therefore, the high current having high voltage generated in the battery module 300 is inhibited from being transferred to the occupant through the vehicle body 100.

Further, when a fire occurs due to the thermal runaway in the battery cell 310 of the battery module 300, the battery module 300 collapses on the upper surface of the lower case 212 of the exterior case 210. In an exemplary form of the present disclosure, since the insulation sheet 400 is provided between the upper surface of the lower case 212 and the bottom surface of the module cover 330 of the battery module 300, it is possible to electrical insulation between the battery module 300 and the battery pack 200 through minimal size of the insulation sheet 400.

As such, since the insulation sheet 400 is provided between the battery module 300 and the battery pack 200, when a fire occurs in the battery pack 200 due to the thermal runaway, it is possible to block the transmission of the high current from the battery module 300 to the vehicle body 100 through the exterior case 210 of the battery pack 200.

Accordingly, when the fire occurs in the battery pack 200 due to the thermal runaway, the high current is not transferred from the battery module 300 to the vehicle body 100 through the exterior case 210 of the battery pack 200 because of the insulation sheet 400. Even if the occupant contacts the vehicle body 100, it is possible to inhibit an electric shock accident.

Further, since the insulation sheet 400 is provided with a flame resisting function, the propagation of the fire to the vehicle body 100 is delayed as much as possible when a fire occurs in the battery pack 200. Thus, it is possible to provide time for the occupant to evacuate from the vehicle.

While this disclosure has been described in connection with what is presently considered to be practical exemplary forms, it is to be understood that the disclosure is not limited to the disclosed forms. On the contrary, it is intended to cover various modifications and equivalent arrangements included within the spirit and scope of the present disclosure.

### DESCRIPTION OF SYMBOLS

100: vehicle body
200: battery pack
210: exterior case
211: upper case
212: lower case
230: battery management system
240: cooling fan
300: battery module
310: battery cell
320: printed circuit board
330: module cover
331: left cover
332: right cover
333: front cover
334: rear cover
335: upper cover
400: insulation sheet

What is claimed is:

1. An apparatus for insulating a battery of an electric vehicle, the apparatus comprising:
a vehicle body;
a battery pack provided in the vehicle body and including an exterior case and a battery module; and
an insulation sheet provided between the battery module and the exterior case,
wherein the exterior case includes an upper case and a lower case provided below the upper case, and
wherein the insulation sheet is provided between an upper surface of the lower case and a module cover forming an exterior of the battery module.

2. The apparatus of claim 1, wherein the insulation sheet is attached to the module cover of the battery module by an adhesive or an adhesive tape.

3. The apparatus of claim 2, wherein the insulation sheet is pressed to the exterior case of the battery pack and is fixedly installed, by the adhesive or the adhesive tape, to the exterior case in a state in which the insulation sheet is bonded to the module cover.

4. The apparatus of claim 1, wherein the insulation sheet is attached to the exterior case of the battery pack through an adhesive or an adhesive tape.

5. The apparatus of claim 4, wherein the insulation sheet is pressed to the module cover of the battery module and is fixedly installed, by the adhesive or the adhesive tape, to the module cover in a state in which the insulation sheet is bonded to the exterior case.

6. The apparatus of claim 1, wherein the insulation sheet is formed to be larger than the battery module.

7. The apparatus of claim 1, wherein the insulation sheet includes a ceramic material.

8. An apparatus for insulating a battery for an electric vehicle, the apparatus comprising:
a vehicle body;
a battery pack provided in the vehicle body and including an exterior case and a battery module;
a cooling fan provided inside the exterior case and configured to cool the battery module;
a battery management system provided inside the exterior case and configured to manage a state of the battery module; and
an insulation sheet provided between the battery module and the exterior case,
wherein the exterior case includes an upper case and a lower case provided below the upper case, and
wherein the insulation sheet is provided between an upper surface of the lower case and a module cover forming exterior of the battery module.

9. The apparatus of claim 8, wherein the insulation sheet is provided between the cooling fan and the battery management system.

10. The apparatus of claim 8, wherein the insulation sheet is attached to the module cover of the battery module by an adhesive or an adhesive tape.

11. The apparatus of claim 10, wherein the insulation sheet is pressed to the exterior case of the battery pack and is fixedly installed, by the adhesive or the adhesive tape, to the exterior case in a state in which the insulation sheet is bonded to the module cover.

12. The apparatus of claim 8, wherein the insulation sheet is attached to the exterior case of the battery pack by an adhesive or adhesive tape.

13. The apparatus of claim 12, wherein the insulation sheet is pressed to the module cover of the battery module and fixedly installed, by the adhesive or the adhesive tape, to the module cover in a state in which the insulation sheet is bonded to the exterior case.

14. The apparatus of claim 8, wherein the insulation sheet is formed to be larger than the battery module.

15. The apparatus of claim 8, wherein the insulation sheet includes a ceramic material.
